(19) United States
(12) Patent Application Publication
(10) Pub. No.: US 2002/0156822 A1
(43) Pub. Date: Oct. 24, 2002

(54) High-speed FFT processing method and FFT processing system

(76) Inventor: Masaharu Tanai, Tokyo (JP)

Correspondence Address: SAMUEL BORODACH, Fish & Richardson P.C., Suite 2800, 45 Rockefeller Plaza, New York, NY, 10111, US

(21) Appl. No.: 10/043,598

(22) Filed: Jan. 10, 2002

(30) Foreign Application Priority Data
Jan. 10, 2001 (JP) P. 2001-002029
Jan. 10, 2001 (JP) P. 2001-002030

(51) Int. Cl. G06F 15/00

(52) U.S. Cl. 708/404

(57) ABSTRACT

A high-speed FFT processing method for subjecting a plurality of FFT data sets to FFT processing, which includes step (a) for dividing the plurality of FFT data (N) into blocks suitable for accessing memory to be used in FFT processing; step (b) for sequentially transferring to the memory the data that have been divided into the blocks; step (c) for FFT processing of the FFT data that have been transferred to the memory; and step (d) for repeating processing pertaining to step (c) to thereby process all the divided blocks, thus effecting high-speed FFT processing.

### BACKGROUND OF THE INVENTION

1. Field of the Invention

The present invention relates to a high-speed FFT processing method applied to the Fast Fourier Transform (FFT)

2. Description of the Related Art

In connection with signal processing, an FFT operation and an Inverted Fast Fourier Transform (IFFT) operation can be performed at high speed, by means of an improvement in the performance of a processing device, such as a digital signal processor (DSP). Because of this, practical analysis of large volumes of data has become feasible. In an FFT operation (hereinafter, a Fourier Transform operation and an Inverted Fourier Transform operation will each be considered an “FFT”), an arithmetic operation is performed through use of all data without involvement of frequency decimation or time decimation. Hence, there must be provided a storage device (hereinafter called “memory”) for real-part data and a storage device for imaginary data.

In the FFT processing, real-part data and imaginary-part data are transferred to a register of the processing device, where the data are subjected to operations (multiplication and addition) with a rotator. Operation results are stored in a memory.

An operation expression; that is, Expression 1, is shown as an FFT computation expression in FIG. 1 (since the FFT computation is a known method, its explanation is omitted).

All the data are repeatedly subjected to the operation.

When the data are actually processed by the processing device, the data are transferred from the device to the register for each operation, and the operation is effected.

Hence, shortening of a transfer time; that is, shortening of a time required to access memory, results in enhancement of speed of FFT processing.

This will now be described by means of, e.g., frequency decimation FFT processing using 16 sets of data. A frequency decimation method represented by Expression 1 is used for frequency decimation.

As in the case of related-art processing shown in FIG. 2-1, the data sets are sorted. In a first phase, input data X0 and input data X8 are subjected to processing represented by Expression 1.

When all the input data sets have been subjected to the processing in the manner as shown in FIG. 2-1, processing for the first phase is completed.

In a second phase, results of processing of the input data X0 and X8 obtained in the first phase and results of the processing of input data X4 and X12 are subjected to the same processing.

Those operations are processed by the same method, and second-phase processing of the data is effected. The processing is further pursued in the third and fourth phases. Finally, output results for Y0 to Y15 can be obtained.

As indicated by a solid line in FIG. 2-2, all the data X0 to X15 are used for determining Y0 data.

All the necessary data sets from X0 to X15 are stored in the memory. Required data are transferred from the memory to the processing device for each operation with regard to all the input data sets X0 to X15, and processing of the data is effected.

When FFT processing is performed by use of a personal computer, in many cases data are stored in, e.g., SDRAM.

At the time of handling of data in the same bank or data in the same row address, the SDRAM requires solely a change in column address. Although resetting of a bank or row address for each data set is not necessary, resetting of a bank or row address is required at the time of handling of data across the bounds of a bank or row address.

Assume the case of FFT processing whose volume cannot be specified by the same row address (see FIG. 3); for example, a case where data X0 and X1 data in a third phsae are assigned to different row addresses.

A first conceivable measure is to transmit an ACT command for setting a row address, as shown in FIG. 5-1. If there is a memory access method (access method A) in which data are read in accordance with a Read command, reading of X0 data and reading of X1 data each involve consumption of 5 clk (the method corresponds to SDRAM).

A second conceivable measure is to set a row address, as shown in FIG. 5-3. If there is a memory access (access method B) in which a column address is set, reading of X0 data and reading of X1 data each involve consumption of 5 clk (the method corresponds to EDO DRAM).

A third conceivable measure is that, in the case where a device adopting a page method as an address designation method (i.e., an instruction system in which, when an absolute address is to be specified, a column address is specified by instruction of a row address, thus reading data) is used as a processing device, such as a CPU and DSP, reading of data X0 and data X1 involves execution of at least two instructions×two data sets=execution of four data sets.

The above processing operations arise every time data are read or written.

In the case of a memory access method in which a command must be set by a bank, a bank setting command must further be transmitted.

For instance, in connection with processing X0 and processing X1, if a bank where a rotator for processing X0 is arranged differs from a bank where a rotator for processing X1 is arranged, setting of a bank address for processing X0 and setting of a row address are performed. Subsequently, data (X0) are read by means of setting of a column address.

Next, after setting of a bank address for processing X1 and setting of a row address have been performed, the data (X1) are read by means of setting of a column address.

After setting of the bank address for processing X0 and setting of the row address have been performed, the data (X0) are written by means of setting of a column address. After setting of the bank address for processing X1 and setting of the row address have been performed, the data (X1) must be written by means of setting of a column address.

As mentioned above, the amount of time required for reading and writing data into memory (i.e., the number of clocks) greatly affects processing.

In the case of 16 FFT processing operations as shown in FIGS. 1 and 2, the influence of the processing is nominal. However, in the case of 16384 FFT processing operations, which represent a practical level, one data set corresponds to four bytes in the floating-point arithmetic. Hence, a 65536-byte data storage capacity is required in a real part as well as in an imaginary part. Accordingly, great influence is imposed on the time required to read and write the data.

If a rotator is provided as a table, a 32768-byte storage area is required. Hence, data must be read and processed across a plurality of row address regions.

In this case, resetting of a row address, such as processing X0 and processing X8192 . . . processing X1 and processing X8193 frequently arises, and the time required for resetting an address cannot be negligible.

The hardware configuration of the related-art FFT processing system will be described.

First will be described a related-art example 1 shown in FIG. 12-1.

This example is to store in a server large volumes of data to be subjected to FFT processing and to effect FFT processing of the data by way of the network, by means of an improvement in a data transfer rate of a network.

In this case, the server is capable of storing large volumes of data; that is, a bulk storage device.

An FFT processing system (e.g., a personal computer or an analyzer) connected to the server by way of the network is a system which is provided with a high-speed access storage device (e.g., an hard disk drive or a magneto-optical drive: A) capable of making an access faster than reading data from the server by way of the network and which performs FFT processing.

If the high-speed access storage device has small capacity and can not effect FFT processing by means of transferring all data, required data cannot be transferred to the storage device by means of an existing FFT processing algorithm. Hence, as shown in FIG. 11, required FFT data must have been transferred by means of a low-speed access from the bulk storage device.

Further, FFT processing per se has not been conceived.

Related-art example 2 shown in FIG. 12-2 will now be described.

In this case, FFT processing is performed by a system comprising a bulk storage device, such as a hard disk drive or a magneto-optical drive; an FFT processing system such as a CPU or DSP; and a storage device (e.g., RAM) which enables a high-speed access.

Even in this case, if the high-speed access storage device has small capacity and cannot effect FFT processing by means of transferring all data, required data cannot be transferred to the storage device by means of an existing FFT processing algorithm, as in the case of the previous example. Hence, as shown in FIG. 11, FFT data must have been transferred for each word to be subjected to FFT processing, by means of a low-speed access.

Further, FFT processing per se has not been conceived.

Next will be related-art example 3 shown in FIG. 12-3.

In this case, FFT processing is performed by a system comprising a bulk storage device such as a hard disk drive or a low-speed bulk storage RAM; a processor such as a DSP; and a high-speed storage device (e.g., internal RAM or high-speed RAM) which enables a high-speed access.

Even in this case, if the high-speed access storage device has small capacity and can not effect FFT processing by means of transferring all data, required data cannot be transferred to the storage device by means of an existing FFT processing algorithm, as in the case of the previous example. Hence, as shown in FIG. 11, FFT data must have been transferred for each word to be subjected to FFT processing, by means of a low-speed access.

Further, FFT processing per se has not been conceived.

### SUMMARY OF THE INVENITON

An object of the invention is to shorten the overall time required to effect FFT processing, by means of shortening the time required to transfer data from memory to a processing register for each round of FFT processing, the transfer arising from the FFT processing.

The present invention enables shortening of the time required to process large volumes of data through FFT processing by means of dividing FFT data.

In order to solve the problems, there is provided a high-speed FFT processing method for subjecting a plurality of FFT data sets to FFT processing, comprising:

step (a) for dividing the plurality of FFT data (N) into blocks suitable for accessing memory to be used in FFT processing;

step (b) for sequentially transferring to the memory the data that have been divided into the blocks;

step (c) for FFT processing of the FFT data that have been transferred to the memory; and

step (d) for repeating processing pertaining to step (c) to thereby process all the divided blocks, thus effecting high-speed FFT processing.

A time required to transfer data from memory to a processing register for each round of processing, which transfer arises in association with FFT processing, is shortened, thereby shortening the overall FFT processing time.

Preferably, the high-speed FFT processing method further comprises a step of dividing the FFT processing of the plurality of FFT data sets into a plurality of stages, and re-arranging the FFT data sets in each stage. As a result, FFT processing can be effected with much smaller memory.

Preferably, division of the FFT data sets in step (a) is performed such that data fall within a range in which resetting of a bank constituting the memory becomes obviated at the time of memory access. In the case of memory constituting a bank, data access becomes feasible without involvement of resetting of a bank. By means of shortening the time required to transfer data from memory to a processing register for each round of processing, the overall FFT processing time can be shortened.

Preferably, division of the FFT data sets in step (a) is performed such that data fall within a range in which resetting of a row address or column address becomes obviated at the time of memory access. As a result, data access becomes feasible without involvement of resetting of a once-set row or column address. Hence, by means of shortening the time required to transfer data from memory to a processing register for each round of processing, the overall FFT processing time can be shortened.

Preferably, the FFT data are formed from real and imaginary parts and are subjected to FFT processing with a rotator.

Preferably, the rotator is preserved in a table beforehand so as to correspond to each of the blocks, thereby enabling much higher FFT processing speed.

Preferably, processing of imaginary data in the FFT data sets is omitted.

Preferably, when the real part or imaginary part of the rotator is zero, multiplication in FFT processing is omitted. Thus, much higher FFT processing speed becomes possible.

In this case, in relation to real signal analysis, when sampled data are subjected to frequency analysis, processing of imaginary-part data can be omitted, or multiplication can be omitted for reasons of the rotator having a real-part value of 1 and an imaginary-part value of 0 or a real-part value of 0 and an imaginary-part value of 1. Thus, the frequency analysis is characterized in that a known speed-up method can be easily reflected on the frequency analysis.

In addition, to solve the problem, there is provided an FFT processing system comprising bulk storage means (a bulk storage device) (11); An FFT processing unit (a processing device) (15); a high-speed access memory (a high-speed access storage device) (12) to be accessed at the time of FFT processing operation of the FFT processing unit; a dividing section (13) for dividing FFT data (N) stored in the bulk storage means into blocks of reciprocal of an integer (M blocks=2 to the m^{th} power) suitable for access to the high-speed access memory; a first transfer section (a transfer device A) (14) for transferring the divided blocks of FFT data from the bulk storage means to the high-speed access memory; and a second transfer section (a transfer device B) (16) for transferring a result of FFT processed performed by the FFT processing unit to an original storage position in the bulk storage means by way of the high-speed access memory and a re-arrangement processing section (17), on the basis of FFT data stored in the high-speed access memory. At the time of FFT processing of large volumes of data, FFT data are divided, and the thus-divided data are transferred from a bulk storage device to a high-speed access memory. Subsequently, FFT processing is effected, to thereby shorten the time required to transfer data to the processing system for each processing. Thus, an overall FFT processing time can be shortened.

Preferably, the FFT processing unit is constituted of the first through n^{th} FFT processing sections, and the first through n^{th} FFT processing sections perform FFT processing operations for the first through n^{th} stages.

Preferably, the FFT processing unit is constituted of M first FFT processing sections (M=2 to the m^{th} power) and K second FFT processing sections (K=2 to the k^{th} power), and the first FFT processing sections perform FFT processing operation for a first stage, and the second FFT processing sections perform FFT processing operations for a second stage. Thus, FFT processing can be implemented with a smaller number of a high-speed access memory devices.

Preferably, the dividing section has a re-arrangement processing function and re-arranges FFT data during a period between a current stage and the next stage. As a result, FFT processing for the next stage can be effected much faster.

Preferably, the FFT data include real-part data and imaginary-part data and are to be subjected to FFT processing with a rotator.

Preferably, the rotator is preserved in a table beforehand so as to correspond to each of the blocks. Hence, much faster FFT processing can be implemented.

Preferably, processing of imaginary data in the FFT data sets is omitted. Hence, much faster FFT processing can be effected.

Preferably, when the real part or imaginary part of the rotator is zero, multiplication in FFT processing is omitted. Hence, much faster FFT processing can be implemented.

### BRIEF DESCRIPTIONS OF DRAWINGS

FIG. 1 is a block diagram showing the concept of the present invention.

FIG. 2 is an illustration showing related-art FFT processing.

FIG. 3 is a schematic diagram showing related-art data access.

FIG. 4 is a schematic diagram showing data access according to the present invention.

FIG. 5 is an illustration showing a read timing for a memory access method.

FIG. 6 shows a flowchart and a sequence of processing of blocks.

FIG. 7 shows selection of an FFT rotator in FFT processing.

FIG. 8 is a schematic representation of high-speed processing that has adopted a known speed-up method.

FIG. 9 is a table showing selection of an FFT rotator and a rotator table.

FIG. 10 is a block diagram showing the configuration of an FFT processing system according to the present invention.

FIG. 11 is a schematic diagram showing related-art data access in FFT processing.

FIG. 12 is an illustration showing the hardware configuration of a related-art FFT processing system.

### DETAILED DESCRIPTION OF THE PRESENT INVENTION

The present invention will be described with reference to the accompanying drawings.

FFT Method Using a Related-Art Hardware Configuration

The principle of a high-speed FFT algorithm—which enables high-speed FFT processing with a hardware configuration identical with the related-art hardware configuration—will be described hereinbelow.

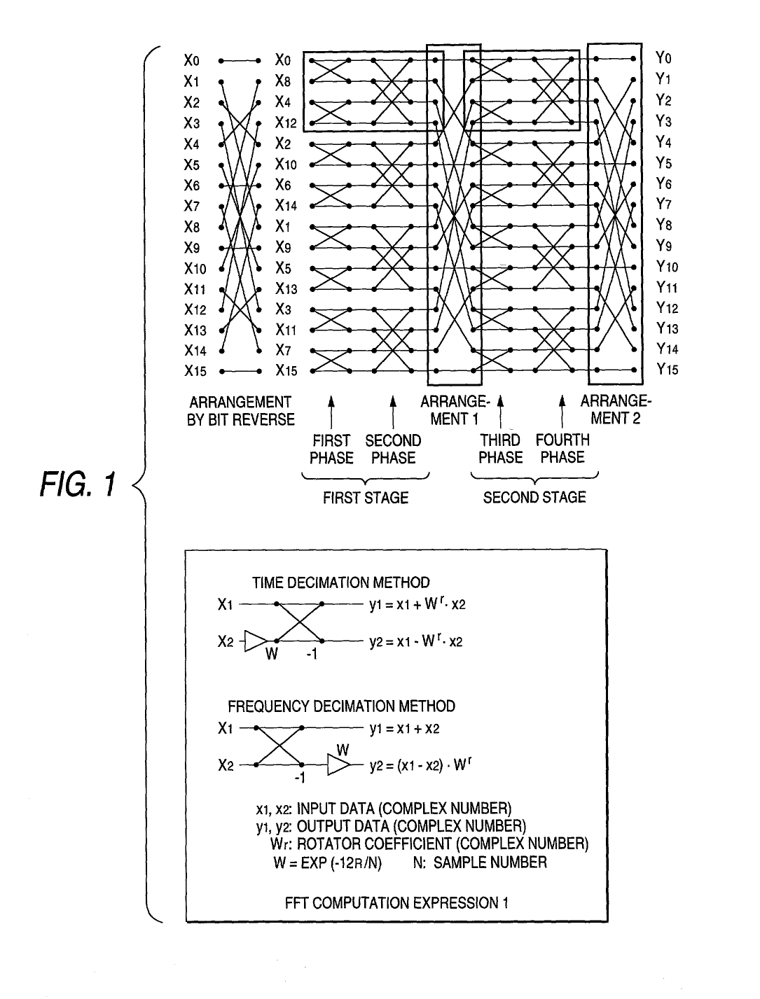

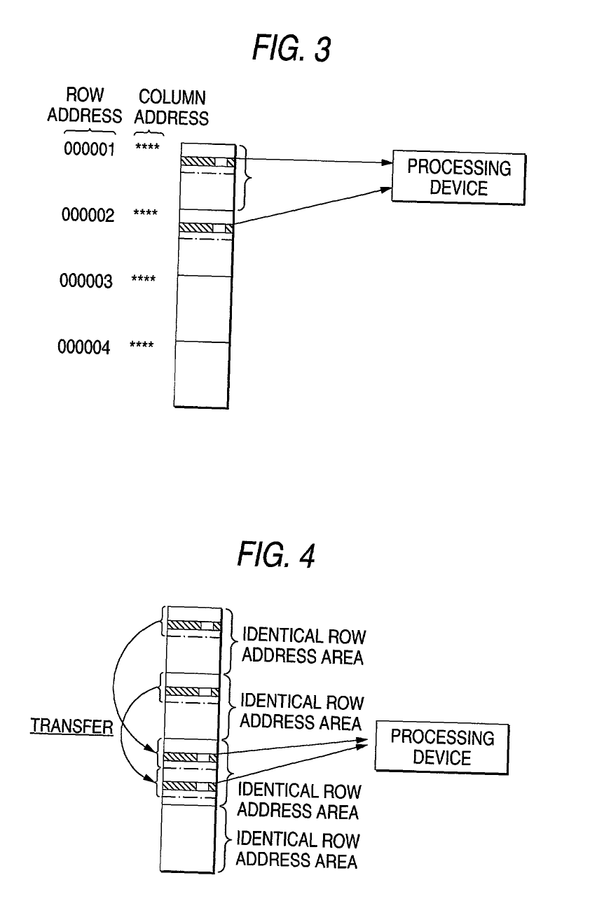

As has been described by reference to FIGS. 3, 5-1, and 5-3, in the related art transfer of data from memory to a register of a processing device requires (for example) 5 clock (clk).

In contrast, data which can be processed in a single block are transferred to a work area assigned a single row address. Subsequently, the data are subjected to FFT processing in the block.

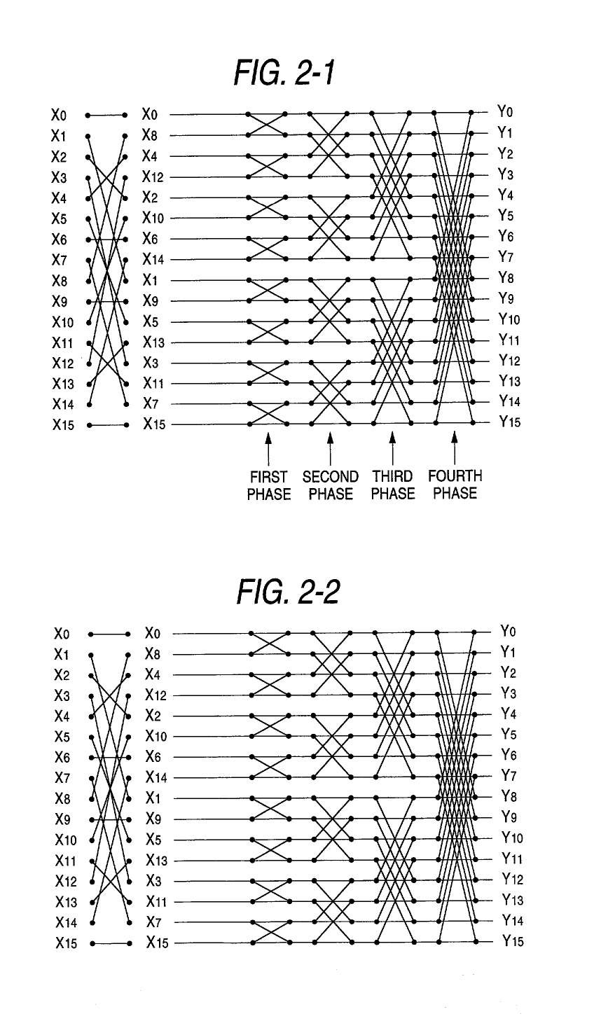

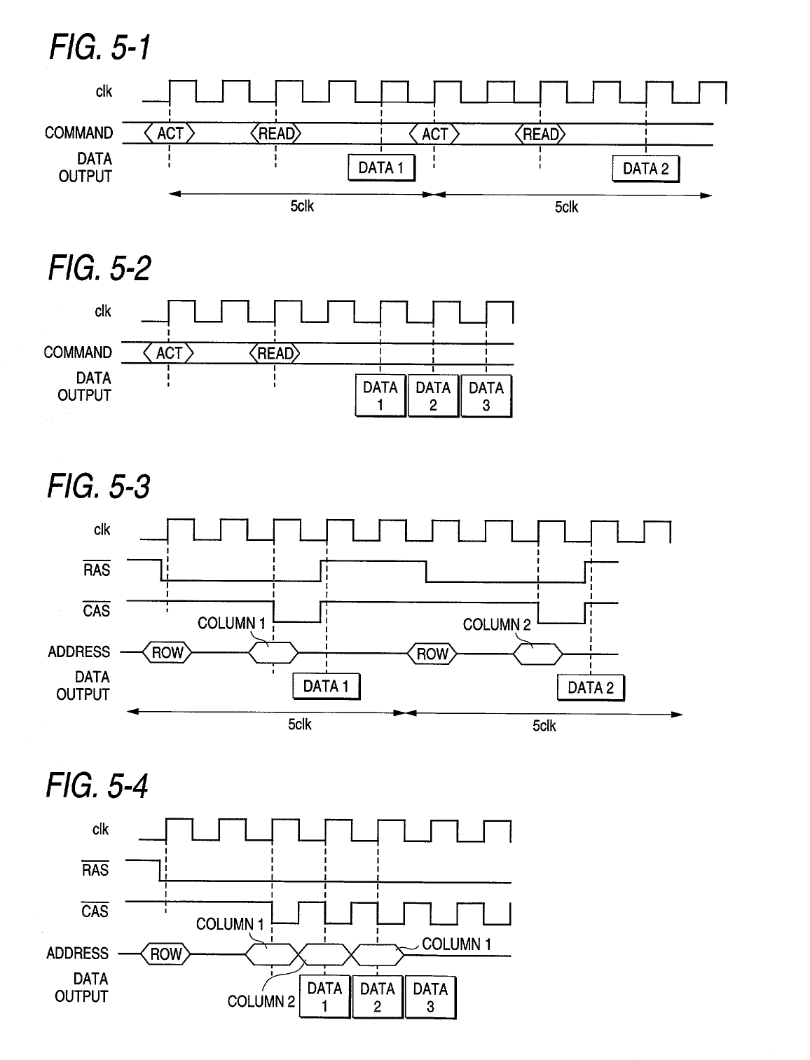

In the case of the memory access method A, data transfer initially requires four clocks. However, once the initial setting has been effected, data can be read at one clock (clk) (see FIG. 5-2).

The same also applies to the memory access method B (see FIG. 5-4).

If the number of data sets is large, four clocks (clk) required at the beginning of setting becomes substantially negligible, and the access time is shortened to one-fifth.

The number of instructions required per address in a CPU can be made such that one instruction×2 data sets=2 instructions×one-half data set. Data transfer is required every time data are read and written. Hence, the transfer time accounts for a large portion of the overall FFT processing.

Next will be described FFT processing of 262144 input data sets.

This case is based on the assumption that 262144 real-part and imaginary-part data sets and 131072 real-part and imaginary-part coefficients of rotators are provided across a plurality of row address regions.

All data sets to be subjected to FFT processing are divided into blocks.

Provided that 512 real-part data, imaginary-part data, and rotators can be stored in a single identical row address area, the number of data sets for one block is 512. Thus, 512 blocks can be made. FFT processing of 512 points (A) is iterated 512 times.

When the data are processed by frequency decimation, data are re-arranged by means of bit reversal (i.e., a common arrangement for FFT processing).

After re-arrangement, 512 data sets from [01]; that is, 512 real-part pieces of data and 512 imaginary-part pieces of data, are transferred to a work area from a real-part [0] through [262143] and an imaginary-part [0] through [262143], respectively.

In this case, the number of blocks must be 2 raised to the m^{th} power for effecting FFT processing.

Further speedup of processing becomes possible by means of transferring rotator data to the work area.

In the first stage, nine stages of FFT processing (butterfly processing; see Expression 1 shown in FIG. 1: 2 to 9^{th} power=512) are effected, and the data are returned to the original storage area.

Next, 512 data sets are transferred from the real-part data [512] and the imaginary-part data [512], and FFT processing is performed again.

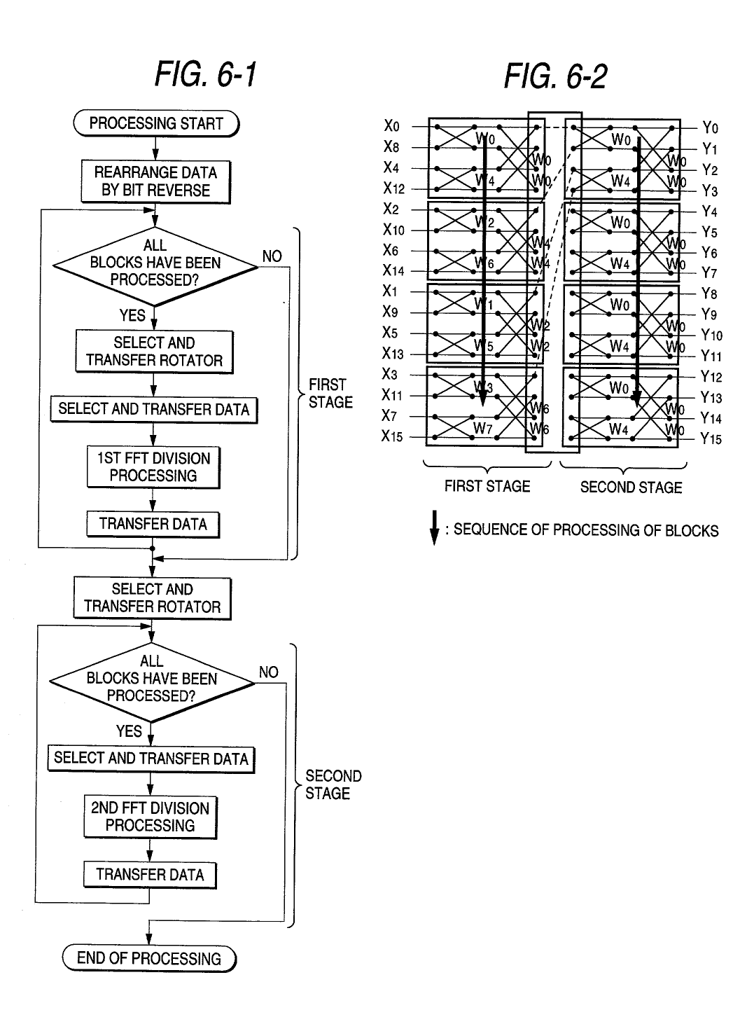

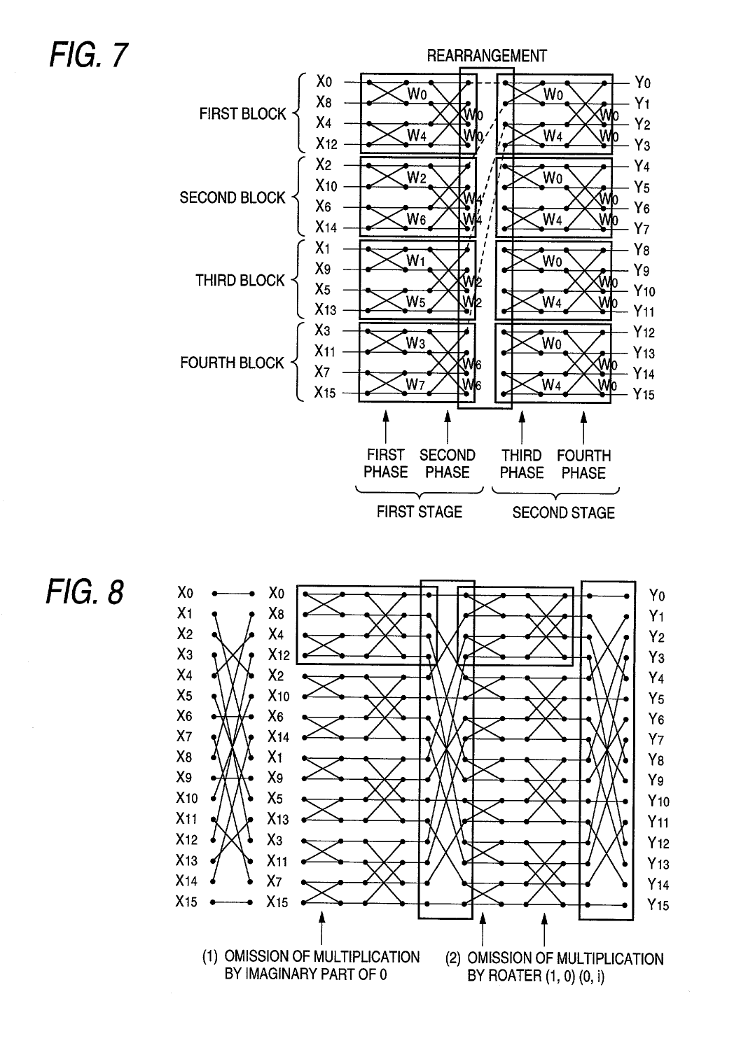

Similar FFT processing is iterated for 512 blocks (the first stage processing shown in FIG. 6-1).

After the end of the first stage processing, 512 data sets are transferred to the work area for every 512 real-part and imaginary data sets for extracting processing data to be used in the second stage. Then, FFT processing is performed. After FFT processing, the data are returned to the original storage area.

Similar FFT processing is iterated for 512 blocks (the second stage processing shown in FIG. 6-1).

As mentioned above, the data transfer associated with FFT processing involves consumption of a long access time because of use of different row addresses. However, the present invention requires only one setting of a row address.

In the related art, resetting of a command and resetting of a row address must be performed for the remaining nine phases of FFT processing; that is, resetting must be performed at an interval corresponding to a nine-fold processing time.

FIG. 6-1 shows a flowchart relating to the first stage processing and the second stage processing. FIG. 6-2 shows the sequence of processing of each of the thus-divided blocks.

Through the processing, the time required to transfer the real-part and imaginary-part data and the real-part and imaginary-part data pertaining to the rotator can be significantly shortened as compared with the case of the related art. Thus, the overall FFT processing is made faster.

As mentioned above, access to data in memory involved in the present invention is characterized in that, as shown in FIG. 4, data accessible in a single row address are stored as a block in the memory of the processing device.

As mentioned above, difficulty is encountered in illustrating all data sets in connection with FFT processing of 262144 data sets. FIG. 1 is a conceptual diagram of a high-speed FFT algorithm according to the present invention that adopts division of data into blocks, re-arrangement of the blocks, and multi-stage processing, by reference to FFT processing of 16 data sets.

In relation to re-arrangement 1 shown in FIG. 1, data to be used are present across another block differing from that used in the first stage, in the FFT processing after the first stage (i.e., the second stage shown in FIG. 1). Hence, the data to be used are re-selected by means of data selection (i.e., rearrangement).

As shown in FIG. 1, the data to be used in the third and fourth phases are also re-selected through re-arrangement 1.

By virtue of rearrangement 1, a processing block is constituted for each thus-selected use data, and the data are transferred for each block. Then, FFT processing is effected.

By means of repeating the processing for all blocks, overall FFT processing is completed.

By means of constituting a plurality of stages through re-arrangement, data are arranged in a single row address area, and FFT processing of the data becomes feasible.

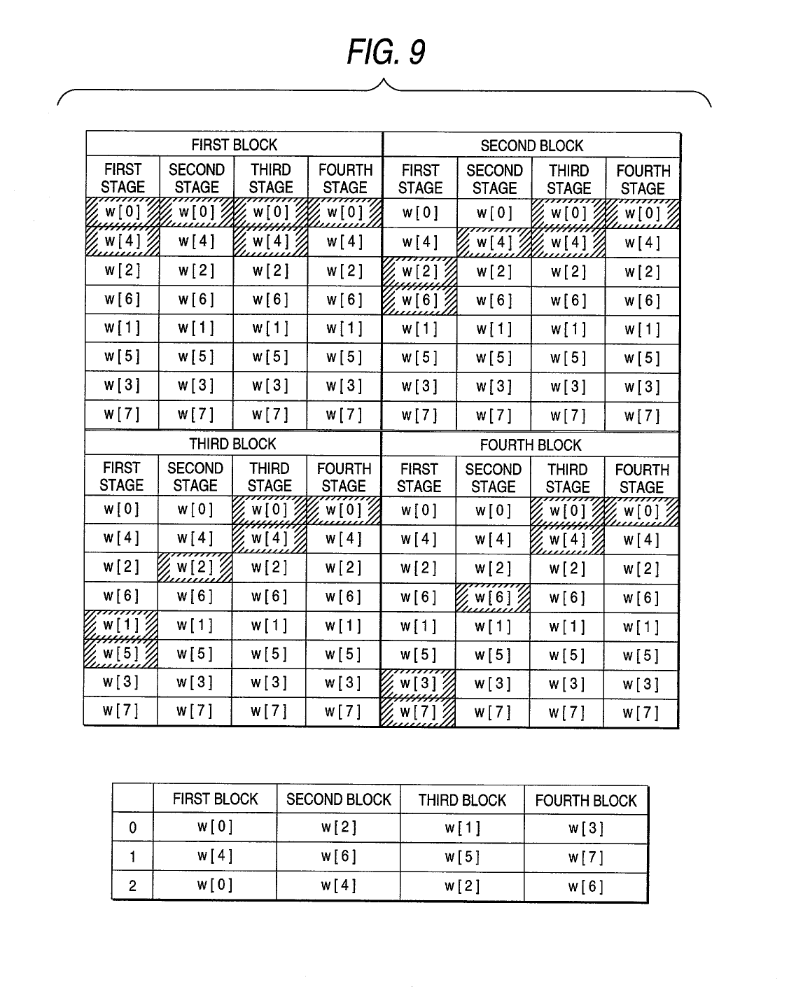

In relation to selection of a rotary coefficient, in the case of FFT processing using frequency decimation, a rotator such as that shown in Table 1 in FIG. 9 is used.

In order to obtain a result of multiplication of a rotator and input data, a coefficient of the rotator is transferred from memory to a register, where the coefficient is computed.

In other words, even in the case of a rotator, a transfer time can be shortened by means of transferring rotator data to a single row address area, and the data are processed in that area.

As can be seen from Table 1 shown in FIG. 9, a rotator used in each stage varies from one block to another. Hence, rotator coefficients used in stages of respective blocks are arranged in order of use. The thus-arranged coefficients are transferred to high-speed memory, thereby obviating use of a rotator without consciousness of a difference in rotators.

As can be seen from Table 2 shown in FIG. 9, in each block rotators are extracted in order from the top of the table, and processing is performed. As a result, a common processing routine can be established.

In this case, extraction of a rotator coefficient can be made realized by means of a simple method of sequentially looking up a table from the top. Hence, speedup of extraction operation can be readily attained.

Even in the second stage, a required rotator coefficient is extracted in the same manner, and the thus-extracted coefficient is transferred to a single row address, thus enhancing the speed of the processing.

In reality, when sampled data are subjected to FFT frequency analysis, real-part data and imaginary-part data which are to be input for FFT processing are computed while sampled data are stored in the real part and “0” is stored in the imaginary part. If the imaginary part is “0” processing of imaginary data can be omitted [which can be realized by changing first phase processing shown in FIG. 8-1, and this processing routine can be used commonly for respective blocks in the first stage].

In reality, data X0 to X15 and data Y0 to Y15 and rotators are expressed by complex numbers, for example:

$$\begin{matrix}X1 = Xr1 ( real part ) + jXi1 ( imaginary part ) \\ X2 = Xr2 ( real part ) + jXi2 ( imaginary part ) \\ Y1 = Yr1 ( real part ) + jYi1 ( imaginary part ) \\ W = Wr ( real part ) + jWi ( imaginary part )\end{matrix}$$

Expression 1 used in the frequency decimation method is:

$$\begin{matrix}Y1 = X1 + X2 ( Xr1 + jXil1 ) + ( Xr2 + jXi2 ) \\ = ( Xr1 + Xr2 ) + j ( Xil1 + Xi2 )\end{matrix} \\ \begin{matrix}Y2 = ( X1 - X2 ) W = \{ ( Xr1 + jXil1 ) - ( Xr2 + jXi2 ) \} ( Wr + jWi ) \\ = \{ ( Xr1 - Xr2 ) + j ( Xil1 + Xi2 ) \} ( Wr + jWi )\end{matrix} \qquad ( 1 )$$

Assuming XR=Xr1−Xr2, and X1=Xi1−Xi2,

Y2=(XR+jX1)(Wr+jWi)

=(XR·Wr−Xi·Wi)+j(XR·Wi+X1·Xr) (1-2)

| | |
|---|---|
| From (1-1), | |
| Yr1 (real part) | = Xr1 + Xr2 |
| Yi1 (imaginary part) | = Xi1 + Xi2 |
| From (1-2), | |
| Yr2 (real part) | = XR · Wr − Xl · Wi |
| Yi2 (imaginary part) | = XR · Wi + Xl · Wr |

This processing is executed for the real and imaginary parts.

If only real-part data are given as sampled data, the imaginary part is computed as “0.”

| | |
|---|---|
| Yr1 (real part) | = Xr1 + Xr2 |
| Yil1 (imaginary part) | = Xi1 + Xi2 = 0 + 0 |
| Yr2 (real part) | = XR · Wr − Xl · Wi |
| | = XR · Wr |
| Yi2 (imaginary part) | = XR · Wi + Xl · Wr |
| | = XR · Wi |

This is limited to only the first phase; since imaginary-part data exist in second and subsequent phases, regular processing is necessary in these phases.

The rotator assumes a real-part value of 1 and an imaginary value of 0 or a real-part value of 0 and an imaginary value of 1. Hence, multiplication of a rotator and processed data can be omitted [which can be realized by changing third-phase processing and fourth-phase processing shown in FIG. 8-2, and this processing routine can be used commonly for respective blocks in the second stage]. A known speedup method can be readily reflected on the processing. Thus, further speedup of the processing becomes feasible.

For instance, in the case of a rotator W=(Wr, Wi)=(1, 0),

| | |
|---|---|
| Yr2 (real part) | = XR · Wr − Xl = XR |
| Yi2 (imaginary part) | = XR · Wi + Xl = Xl |
| In the case of a rotator W | = (Wr, Wi) = (0, j), |
| Yr2 (real part) | = XR · Wr − Xl · Wi = −Xl |
| Yi2 (imaginary part) | = XR · Wi + Xl · Wr = XR |

Thus, processing can be omitted.

When FFT processing of 262144 points is effected by use of a common personal computer equipped with a Pentium CPU, the FFT processing time can be shortened to a fraction of that required in a case where the present invention is not adopted.

The processing according to the present invention does not need to be set strictly in a row address area.

In connection with FFT processing of 262144 points, data are divided into a sufficiently small number of 512 blocks or into 1024 blocks, and the frequency of resetting of a row address and the frequency of resetting of a bank are diminished, thus enabling high-speed processing.

Data sets to be subjected to FFT processing in the first stage do not need to be made equal in number with those to be subjected to FFT processing in the second stage. The only requirement is that data sets are in a number which can be subjected to FFT processing, such as 2 to the m^{th} power or 2 to the k^{th} power. Further, the number of stages maybe increased to 3 or 4 rather than a single stage being divided into two.

Apparatus Suitable for Performing the Process

An FFT processing system suitable for performing the process will be described. The FFT processing system comprises a bulk storage device, a high-speed access storage device, and an FFT processing device, wherein FFT data are divided, and the thus-divided data are transferred from the bulk storage device to the high-speed access storage device; wherein FFT processing effected between the FFT processing device and the high-speed access storage device; and wherein the data that have been processed in a stage are re-arranged and subjected again to FFT processing on a per-block basis.

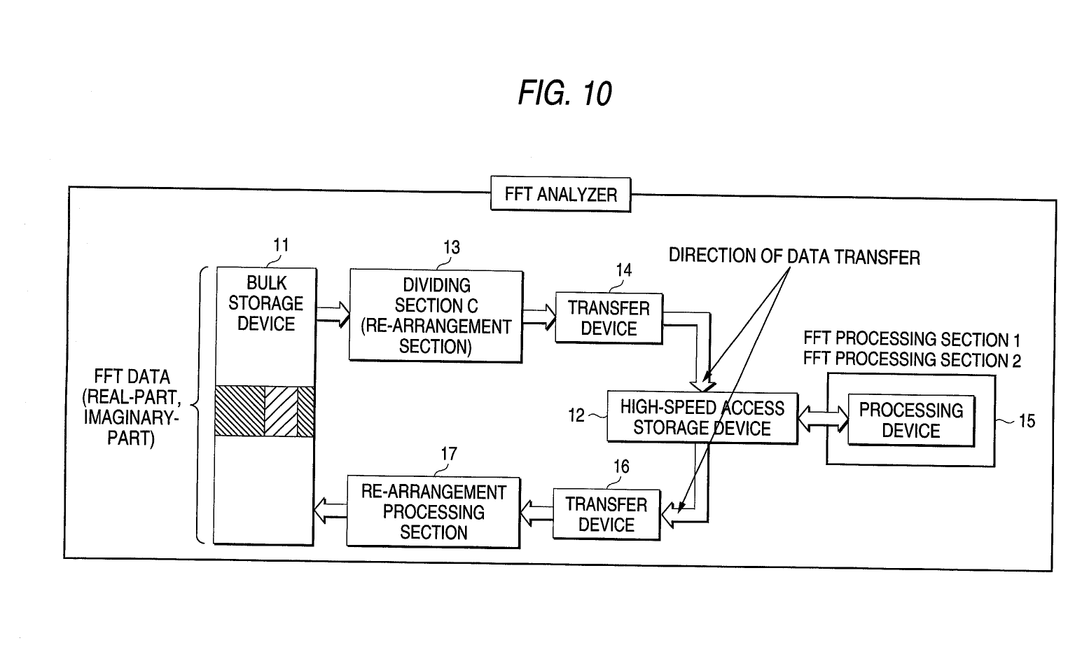

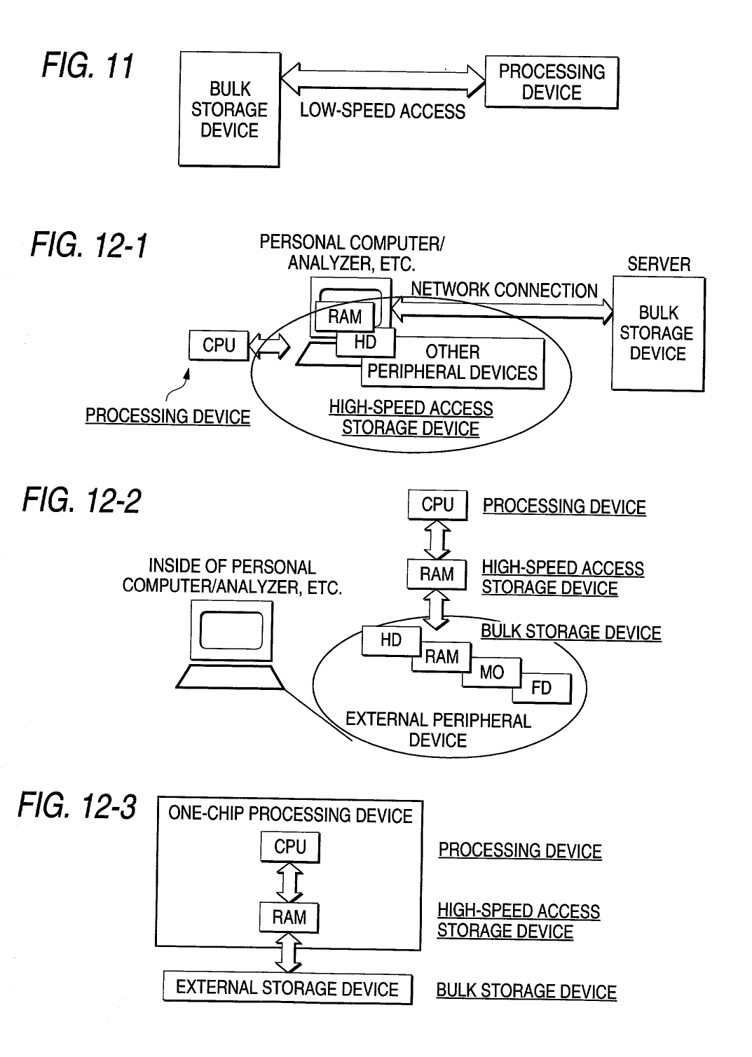

A hardware configuration of the present invention will now be described by reference to FIG. 10.

FFT processing of 262144 data sets is performed on the basis of the assumption that This case is based on the assumption that 262144 real-part and imaginary-part FFT data sets are stored in a bulk storage device

First, all data sets to be subjected to FFT processing are divided into blocks.

Provided that 512 real-part data, imaginary-part data, and rotators can be stored in a high-speed access storage device, the number of data sets for one block is 512 (a). Thus, 512 blocks (b) can be made.

Hence, processing of all FFT data is completed, by means of iterating FFT processing of 512 data sets (a) 512 times (b)

When the data are processed by frequency decimation, data are re-arranged by means of bit reversal (bit reversal is a common method in FFT, and hence its explanation is omitted. If data stored in the bulk storage device have already been subjected to bit reversal, a necessity for re-arrangement of data is obviated).

After re-arrangement, 512 data sets from [0] to [511]; that is, 512 real-part pieces of data and 512 imaginary-part pieces of data, are transferred to a work area from a real-part [0] through [262143] and an imaginary-part [0] through [262143], respectively.

The number of blocks must be 2 raised to the m^{th} power for effecting FFT processing.

A transfer device A14 transfers the thus-extracted 512 data sets to a high-speed access storage device 12.

A rotator may be prepared by an FFT processing section 15-1. At the time of FFT processing, the rotator is preferably provided in the high-speed access storage device 12.

The FFT processing section 1 effects nine phases of FFT processing (butterfly processing; see Expression 1: 2 to 9^{th} power=512) on the basis of 512 real-part pieces of data, 512 imaginary-part pieces of data, and a rotary coefficient, all being stored in the high-speed access storage device 12. A result of processing (c) performed in the first stage is output to the high-speed access storage device 12.

A transfer device B16 transfers the processing result from the high-speed access storage device 12 to a re-arrangement processing section D17.

The re-arrangement processing section D17 stores the data into memory locations [0] to [511] for the real-part data and memory locations [0] to [511] for the imaginary-part data (i.e., original storage positions) in the bulk storage device.

Similarly, the real-part data and the imaginary-part data are transferred to the high-speed access storage device 12 from the bulk storage device every 512 data sets, through use of a dividing section C13 and the transfer device A14. An FFT processing section then performs FFT processing.

An operation for storing a result of FFT processing into the bulk storage device 11 through use of the transfer device B16 and the re-arrangement processing section D17 is iterated 512 times (first-stage processing shown in FIG. 6-1).

In order to extract processing data to be used in the second stage after completion of the first-stage processing, the dividing section C (or the re-arrangement section) extracts 512 pieces of data from the real-part data sets [0] to [511] and the imaginary-part data sets [0] to [511].

The transfer device A14 transfers the thus-extracted 512 real-part pieces of data and the 512 imaginary-part pieces of data to the high-speed access storage device 12.

An FFT processing section 2 effects remaining nine phases of FFT processing (butterfly processing; see Expression 1: 2 to 9^{th} power=512) on the basis of 512 real-part pieces of data, 512 imaginary-part pieces of data, and the rotary coefficient, all being stored in the high-speed access storage device 12. A result of processing (c) performed in the first stage is output to the high-speed access storage device 12.

In this case, since there are 262144 pieces of FFT data, the data have been divided into 512×512. However, the number of data blocks for the first stage may be 1024, and the number of data blocks for the second stage may be 256.

In this case, the FFT processing section 1 can perform FFT processing of 1024 pieces of data, and the FFT processing section 2 perform processing of 256 pieces of data. Hence, the FFT processing section of a processing device 15 shown in FIG. 10 is divided into two parts: that is, the processing section 1 and the processing section 2.

The transfer device B16 transfers a result of FFT processing from the high-speed access storage device 12 to the re-arrangement processing section D17. The re-arrangement processing section D17 transfers data from the real-part data [0] and the imaginary-part data [0] (to the original storage locations) every 512 pieces of data.

Similarly, 512 real-part pieces of data from the real-part data stored in the bulk storage device 11 and 512 imaginary-part pieces of data from the imaginary-part data stored in the bulk storage device 11 are transferred to the high-speed access storage device through use of the dividing section C13 and the transfer device A14. Then, the FFT processing section 2 performs FFT processing operation.

An operation for storing a result of FFT processing into the bulk storage device 11 through use of the transfer device B and the re-arrangement processing section D is iterated 512 times (second-stage processing shown in FIG. 6-1).

FIG. 6-1 shows a flowchart of the above processing, and FIG. 6-2 shows a sequence of processing of blocks.

Through the processing, the time required to transfer real-part and imaginary-part pieces of data between the FFT processing device and the storage device is shortened, thus enhancing the overall speed of FFT processing.

When the above configuration is actually realized by hardware, the bulk storage device can be embodied as external RAM; the transfer devices A and B, the dividing section C, the re-arrangement section D, the FFT processing section 1, and the FFT processing section 2 can be embodied as a DSP or a CPU; and the high-speed access storage device can be embodied as a CPU or internal RAM.

Since FFT data of 262144 is large, there will now be described division of 16 pieces of FFT data, re-arrangement of the divided pieces of data, and multi-stage processing of the data, thereby describing the concept of a high-speed FFT processing algorithm according to the present invention by reference to FIG. 1.

In relation to re-arrangement 1, data to be used are present across another block differing from that used in the first stage, in the FFT processing after the first stage (i.e., the second stage shown in FIG. 10). Hence, the data to be used are re-selected by means of data selection (i.e., rearrangement).

As shown in FIG. 1, data to be used in third and fourth phases are re-selected through re-arrangement 1. During phases subsequent to re-arrangement 1, a processing block is constituted for each thus-selected data to be used, and the data retransferred on a per-block basis. Thus, FFT processing is effected.

All FFT processing operations are completed by means of iteration of the processing for all blocks. A plurality of stages are constituted by means of re-arrangement, and hence data can be provided in the high-speed storage device and subjected to FFT processing.

Next will be described selection of a rotator coefficient. In the case of FFT processing employing frequency decimation, a rotator is used in the manner as represented by Table 1 shown in FIG. 9.

In order to produce a result by means of multiplication of a rotator with input data, a coefficient of a rotator is transferred to a register, where the coefficient is computed.

As can be seen from Table 2 shown in FIG. 9, a rotator to be used in each phase differs from one block to another block. Hence, rotator coefficients to be used in respective stages of each block must be prepared and arranged in the order in which the coefficients are to be used. The rotator coefficients are prepared in the high-speed access storage device beforehand or transferred from the bulk storage device. However, if the coefficients are arranged in the form of a table, there can be established a common processing routine.

In each block, a rotator is sequentially extracted from top of the table, as represented in Table 2 shown in FIG. 9, and the rotator is subjected to processing.

Extraction of a rotator coefficient can be made realized by means of a simple method of sequentially looking up a table from the top. Hence, speedup of extraction operation can be readily attained. A required rotator coefficient is extracted in the same manner in a second stage.

When sampled data are subjected to FFT frequency analysis, real-part data and imaginary-part data which are to be input for FFT processing are computed while sampled data are stored in the real part and “0” is stored in the imaginary part. If the imaginary part is “0,” processing of imaginary data can be omitted [which can be realized by changing first phase processing shown in FIG. 8-1, and this processing routine can be used commonly for respective blocks in the first stage].

Data X0 to X15 and data Y0 to Y15 and rotators are expressed by complex numbers, for example:

$$\begin{matrix}X1 = Xr1 ( real part ) + jXi1 ( imaginary part ) \\ X2 = Xr2 ( real part ) + jXi2 ( imaginary part ) \\ Y1 = Yr1 ( real part ) + jYi1 ( imaginary part ) \\ W = Wr ( real part ) + jWi ( imaginary part )\end{matrix}$$

Expression 1 used in the frequency decimation method is:

$$\begin{matrix}Y1 = X1 + X2 ( Xr1 + jXil1 ) + ( Xr2 + jXi2 ) \\ = ( Xr1 + Xr2 ) + j ( Xil1 + Xi2 )\end{matrix} \\ \begin{matrix}Y2 = ( X1 - X2 ) W = \{ ( Xr1 + jXil1 ) - ( Xr2 + jXi2 ) \} ( Wr + jWi ) \\ = \{ ( Xr1 - Xr2 ) + j ( Xil1 + Xi2 ) \} ( Wr + jWi )\end{matrix} \qquad ( 1 )$$

Assuming XR=Xr1−Xr2 and X1=Xi1−Xi2:

$$\begin{matrix}Y2 = ( XR + jX1 ) ( Wr + jWi ) \\ = ( XR \cdot Wr - Xi \cdot Wi ) + j ( XR \cdot Wi + X1 \cdot Xr )\end{matrix} \qquad \text{(1-2)}$$

| | |
|---|---|
| From (1-1), | |
| Yr1 (real part) | = Xr1 + Xr2 |
| Yi1 (imaginary part) | = Xi1 + Xi2 |
| From (1-2), | |
| Yr2 (real part) | = XR · Wr − Xl · Wi |
| Yi2 (imaginary part) | = XR · Wi + Xl · Wr |

This processing is executed for the real and imaginary parts.

If only real-part data are given as sampled data, the imaginary part is computed as “0.”

| | |
|---|---|
| Yr1 (real part) | = Xr1 + Xr2 |
| Yil1 (imaginary part) | = Xi1 + Xi2 = 0 + 0 |
| Yr2 (real part) | = XR · Wr − Xl · Wi = XR · Wr |
| Yi2 (imaginary part) | = XR · Wi + Xl · Wr = XR · Wi |

This is limited to only the first phase; since imaginary-part data exist in second and subsequent phases, regular processing is necessary in these phases.

The rotator assumes a real-part value of 1 and an imaginary value of 0 or a real-part value of 0 and an imaginary value of 1. Hence, multiplication of a rotator and processed data can be omitted [which can be realized by changing third-phase processing and fourth-phase processing shown in FIG. 8-2, and this processing routine can be used commonly for respective blocks in the second stage]. A known speedup method can be readily reflected on the processing. Thus, further speedup of the processing becomes feasible.

For instance, in the case of a rotator W=(Wr, Wi)=(1, 0):

| | |
|---|---|
| Yr2 (real part) | = XR · Wr − Xl = XR |
| Yi2 (imaginary part) | = XR · Wi + Xl = Xl |
| In the case of a rotator W | = (Wr, Wi) = (0, j): |
| Yr2 (real part) | = XR · Wr − Xl − Wi = −Xl |
| Yi2 (imaginary part) | = XR · Wi + Xl · Wr = XR |

Thus, processing can be omitted.

Data sets to be subjected to FFT processing in the first stage do not need to be made equal in number with those to be subjected to FFT processing in the second stage. The only requirement is that data sets are in a number which can be subjected to FFT processing, such as 2 to the m^{th} power or 2 to the k^{th} power. Further, the number of stages may be set to 1 through n rather than a single stage being divided into two.

According to a first aspect of the invention, there is provided a high-speed FFT processing method for subjecting a plurality of FFT data sets to FFT processing, comprising:

step (a) for dividing the plurality of FFT data (N) into blocks suitable for accessing memory to be used in FFT processing;

step (b) for sequentially transferring to the memory the data that have been divided into the blocks;

step (c) for FFT processing of the FFT data that have been transferred to the memory; and

step (d) for repeating processing pertaining to step (c) to thereby process all the divided blocks, thus effecting high-speed FFT processing.

A time required to transfer data from memory to a processing register for each round of processing, which transfer arises in association with FFT processing, is shortened, thereby shortening the overall FFT processing time.

Preferably, the high-speed FFT processing method further comprises a step of dividing the FFT processing of the plurality of FFT data sets into a plurality of stages, and re-arranging the FFT data sets in each stage. As a result, FFT processing can be effected with much smaller memory.

Preferably, division of the FFT data sets in step (a) is performed such that data falls within a range in which resetting of a bank constituting the memory becomes obviated at the time of memory access. In the case of memory constituting a bank, data access becomes feasible without involvement of resetting of a bank. By means of shortening the time required to transfer data from memory to a processing register for each round of processing, the overall FFT processing time can be shortened.

Preferably, division of the FFT data sets in step (a) is performed such that data fall within a range in which resetting of a row address or column address becomes obviated at the time of memory access. As a result, data access becomes feasible without involvement of resetting of a once-set row or column address. Hence, by means of shortening the time required to transfer data from memory to a processing register for each round of processing, the overall FFT processing time can be shortened.

Preferably, the FFT data are formed from real and imaginary parts and are subjected to FFT processing with a rotator.

Preferably, the rotator is preserved in a table beforehand so as to correspond to each of the blocks, thereby enabling much higher FFT processing speed.

Preferably, processing of imaginary data in the FFT data sets is omitted.

Preferably, when the real part or imaginary part of the rotator is zero, multiplication in FFT processing is omitted. Thus, much higher FFT processing speed becomes possible.

In this case, in relation to real signal analysis, when sampled data are subjected to frequency analysis, processing of imaginary-part data can be omitted, or multiplication can be omitted for reasons of the rotator having a real-part value of 1 and an imaginary-part value of 0 or a real-part value of 0 and an imaginary-part value of 1. Thus, the frequency analysis is characterized in that a known speed-up method can be easily reflected on the frequency analysis.

According to the present invention, there is provided an FFT processing system comprising bulk storage means (a bulk storage device) (11); An FFT processing unit (a processing device) (15); a high-speed access memory (a high-speed access storage device) (12) to be accessed at the time of FFT processing operation of the FFT processing unit; a dividing section (13) for dividing FFT data (N) stored in the bulk storage means into blocks of reciprocal of an integer (M blocks=2 to the m^{th} power) suitable for access to the high-speed access memory; a first transfer section (a transfer device A) (14) for transferring the divided blocks of FFT data from the bulk storage means to the high-speed access memory; and a second transfer section (a transfer device B) (16) for transferring a result of FFT processed performed by the FFT processing unit to an original storage position in the bulk storage means by way of the high-speed access memory and a re-arrangement processing section (17), on the basis of FFT data stored in the high-speed access memory. At the time of FFT processing of large volumes of data, FFT data are divided, and the thus-divided data are transferred from a bulk storage device to a high-speed access memory. Subsequently, FFT processing is effected, to thereby shorten the time required to transfer data to the processing system for each processing. Thus, an overall FFT processing time can be shortened.

Preferably, the FFT processing unit is constituted of the first through n^{th} FFT processing sections, and the first through n^{th} FFT processing sections can perform FFT processing operations for the first through n^{th} stages.

Preferably, the FFT processing unit is constituted of M first FFT processing sections (M=2 to the m^{th} power) and K second FFT processing sections (K=2 to the k^{th} power), and the first FFT processing sections perform FFT processing operation for a first stage, and the second FFT processing sections perform FFT processing operations for a second stage. Thus, FFT processing can be implemented with a smaller number of a high-speed access memory devices.

Preferably, the dividing section has a re-arrangement processing function and re-arranges FFT data during a period between a current stage and the next stage. As a result, FFT processing for the next stage can be effected much faster.

Preferably, the FFT data include real-part data and imaginary-part data and are to be subjected to FFT processing with a rotator.

Preferably, the rotator is preserved in a table beforehand so as to correspond to each of the blocks. Hence, much faster FFT processing can be implemented.

Preferably, processing of imaginary data in the FFT data sets is omitted. Hence, much faster FFT processing can be effected.

Preferably, when the real part or imaginary part of the rotator is zero, multiplication in FFT processing is omitted. Hence, much faster FFT processing can be implemented.

What is claimed is:

1. A high-speed FFT processing method comprising:
dividing a plurality of data (N) into a plurality of blocks suitable for accessing memory to be used in FFT processing;
sequentially transferring to the memory the blocks;
performing FFT processing of the FFT data in each of the block transferred to the memory; and
repeating the FFT processing until the data in all of the blocks are processed.

2. The high-speed FFT processing method according to claim 1, further comprising:
dividing the FFT processing of the plurality of FFT data into a plurality of stages; and
re-arranging the FFT data between each of the stages.

3. The high-speed FFT processing method according to claim 1, wherein the FFT data is divided such that the data falls within a range to obviate resetting of a bank constituting the memory at the time of memory access.

4. The high-speed FFT processing method according to claim 1, wherein the FFT data is divided such that the data falls within a range to obviate resetting of a row address or column address at the time of memory access.

5. The high-speed FFT processing method according to claim 1, wherein the FFT data constitutes real and imaginary parts and are subjected to FFT processing with a rotator.

6. The high-speed FFT processing method according to claim 5, wherein the rotator is preserved in a table in advance to correspond to each of the blocks.

7. The high-speed FFT processing method according to claim 5, wherein the processing of imaginary data in the FFT data is omitted.

8. The high-speed FFT processing method according to claim 5, wherein multiplication in FFT processing is omitted when the real part or imaginary part of the rotator is zero.

9. An FFT processing system comprising:
a bulk storage unit for storing a plurality of data (N);
an FFT processing unit for performing FFT processing;
a high-speed access memory accessed at the time of the FFT processing;
a dividing section for dividing the plurality of data into M blocks suitable for access to the high-speed access memory, where M=2^{m};
a first transfer section for transferring the blocks of the data from the bulk storage unit to the high-speed access memory; and
a second transfer section for transferring a result of FFT processed performed by the FFT processing unit to an original storage position in the bulk storage unit through the high-speed access memory and a re-arrangement processing section, on the basis of data stored in the high-speed access memory.

10. The FFT processing system according to claim 9, wherein the FFT processing unit comprises a first through n^{th} FFT processing sections; and
the first through n^{th} FFT processing sections perform FFT processing operations for first through n^{th} stages.

11. The FFT processing system according to claim 9, wherein the FFT processing unit comprises:
M number of first FFT processing sections (M=2^{m}); and
K of second FFT processing sections (K=2^{k}); and
the first FFT processing sections perform FFT processing operation for a first stage, and the second FFT processing sections perform FFT processing operations for a second stage.

12. The FFT processing system according to claim 11, wherein the dividing section has a re-arrangement processing function for re-arranging the data during a period between a current stage and the next stage.

13. The FFT processing system according to claim 9, wherein the FFT real-part data and imaginary-part data and are to be subjected to FFT processing with a rotator.

14. The FFT Processing system according to claim 13, wherein the rotator is preserved in a table in advance to correspond to each of the blocks.

15. The FFT processing system according to claim 13, wherein the processing of imaginary data in the data is omitted.

16. The FFT processing system according to claim 1, wherein, multiplication in the FFT processing is omitted when the real part or imaginary part of the rotator is zero.
